(19) United States
(12) Patent Application Publication
(10) Pub. No.: US 2021/0130512 A1
(43) Pub. Date: May 6, 2021

(54) A METHOD OF SYNTHESIZING A WATER-DISPERSIBLE CONDUCTIVE POLYMERIC COMPOSITE

(71) Applicant: Agency for Science, Technology and Research, Singapore (SG)

(72) Inventors: Tao Tang, Singapore (SG); Aung Ko Ko Kyaw, Singapore (SG); Qiang Zhu, Singapore (SG); Jian Wei Xu, Singapore (SG)

(21) Appl. No.: 16/491,783

(22) PCT Filed: Mar. 7, 2018
(86) PCT No.: PCT/SG2018/050105

§ 371 Date: Sep. 6, 2019

(30) Foreign Application Priority Data
Mar. 7, 2017 (SG) 10201701829X

(51) Int. Cl. C08F 32/08; C08L 25/18; B01D 71/34; C08F 2/18; C08F 6/24; C08F 4/26

(52) U.S. Cl. CPC C08F 32/08; C08L 25/18; C08F 4/26; C08F 2/18; C08F 6/24; B01D 71/34

(57) ABSTRACT

A method of synthesizing a water-dispersible conductive polymeric composite comprising mixing an aqueous suspension comprising optionally substituted azulene monomers and a dopant precursor such as polystyrene sulfonic acid with an oxidizing agent and a catalyst to form a doped poly(azulene) suspension wherein the poly(azulene)/dopant molar ratio is 1:1 to 1:6. The doped poly(azulene) suspension is then contacted with acidic and basic resins to remove the oxidizing agent and catalyst. The resulting suspension is then filtered through a membrane such as polyvinylidene fluoride (PVDF) to afford a purified suspension comprising the water-dispersible conductive polymeric composite. A water-dispersible conductive polymeric composite comprising an optionally substituted poly(azulene) doped by a dopant such as polystyrene sulfonate wherein the poly(azulene)/dopant molar ratio is 1:1 to 1:6 is also disclosed.

### CROSS-REFERENCE TO RELATED APPLICATION

This application claims the benefit of priority of Singapore Patent Application No. 10201701829X, filed 7 Mar. 2017, the content of it being hereby incorporated by reference in its entirety for all purposes.

### TECHNICAL FIELD

The present disclosure relates to a method of synthesizing a water-dispersible conductive polymeric composite. The present disclosure also relates to such a water-dispersible conductive polymeric composite.

### BACKGROUND

Ever since polyacetylene was discovered to have extremely high electrical conductivity, the field of conducting polymers has attracted the interest of many scientists. These conducting polymers have numerous applications because they possess a combination of the properties of polymers (low cost, good film-forming ability and easy functionalization) and metals (good electrical conductivity). In this regard, conducting polymers have been widely used in thermoelectric and optoelectronic devices, including liquid crystal displays (LCDs), light-emitting diodes (LEDs), solar cells, touch panel displays, lasers, organic field-effect transistors (OFETs), bio-sensing and detectors. In particular, thermoelectric (TE) devices are able to directly produce an electrical current or electrical power from a temperature gradient.

TE applications in the industry, including wireless sensor network (WSN) applications, have increased significantly. The global market for TE materials is projected to reach USD 547.7 million by end of year 2020, at a compounded annual growth rate of 13.8% from year 2015 onwards. Overall, military and WSN applications occupy over 50% of the market.

Most of the TE materials are conventionally inorganic, such as skutterudites, half-Heusler alloys, clathrates and/or pentatellurides. For example, bismuth telluride is a commercially available raw material for a Peltier cooler and shows the best performance in terms of high efficiency. The application of telluride, however, is restricted as it is toxic and rare. There is thus a need to develop low cost, non-toxic, large scale and processable TE materials, and investigations on carbon nanotubes, graphene, thin metals, metal grids and other conducting polymers are carried out in response to this.

Besides those requirements, low cost manufacturing, simple processing, flexibility and possibility of roll-to-roll mass production are to be considered. These are, however, not fulfilled by conventional conducting polymers. For example, the application of conventional conducting polymers, such as polypyrrole and polythiophene, are severely limited by their poor processability, as they are intractable and insoluble in water and organic solvents when in their conductive state. In another example, soluble conductive polymers such as polyanilines may be dispersed in some organic solvents, like m-cresol, but only after doping with bulky anions.

More recently, poly(3,4-ethylenedioxythiophene) (PEDOT), a commonly used commercial conducting polymer showing high conductivity and transparency, may be regarded as a promising material for TE organic devices because it can be used to fabricate cost effective and flexible devices, and can be manufactured by roll-to-roll mass production. PEDOT, which is insoluble in most solvents, can be dispersed in water by using polystyrene sulfonate (PSS) as a counter ion, in which PSS also serves as an excellent oxidizing agent, charge compensator, and as a template for polymerization. High quality PEDOT:PSS films can be readily coated on the substrates through conventional solution-processing techniques. However, such as-prepared PEDOT:PSS film from aqueous PEDOT:PSS solution usually has a conductivity of about 0.01 S/cm to 0.1 S/cm and a Seebeck coefficient of 22 μV/K. Several methods, including the addition of an organic compound, such as ethylene glycol, dimethyl sulfoxide (DMSO), anionic surfactant or ionic liquid, into a PEDOT:PSS aqueous solution, and post-treatment of PEDOT:PSS films with a polar organic compound or inorganic acid, have been used to enhance electrical conductivity. Upon such treatment, the electrical conductivity may be as high as 4000 S/cm. The post-treatment can also generate its highest ZT (i.e. the thermoelectric figure of merit) of 0.42 (power factor: 440 μW/m/K²). Apart from such methods, different polymerization techniques may be adopted to achieve high conductivity.

Despite the above, PEDOT has to be stored in refrigeration, faces issues of high price and instability at room temperature. Moreover, the Seebeck coefficient for PEDOT:PSS is too low to achieve the high ZT for real life applications in TE devices.

Conducting TE polymers still remain limited. It is also too economically demanding for conventional TE polymers to have good stability, high electrical conductivity, high Seebeck coefficient, low thermal conductivity, low cost and good processability for satisfying various applications. In addition, there may be a limited number of suppliers developing technology on conductive TE polymers and/or providing such conductive TE polymers. There is therefore a need to provide an alternative polymer that is conductive and/or thermoelectrical.

Holistically, TE materials have been studied over the past several decades but their applications are still limited by their low efficiency. Inorganic materials have been explored due to their high ZT values. For example, p-type Bi₂Te₃/Sb₂Te₃ superlattices have a ZT of 2.4 while n-type PbSe_{0.98}Te_{0.02}/PbTe quantum-dot superlattices have a ZT of 3 at 550 K. Inorganic TE materials, however, also suffer from high cost of raw materials, poor processability and may give rise to heavy metal pollution. To mitigate these, a variety of alternatives were investigated. For example, conductive carbon nanotubes (CNT) coatings have become a prospective substitute due to its excellent electrical conductivity as well as a wide range of processing methods that include spraying, spin-coating, casting, layer-by-layer deposition, and langmuir-Blodgett deposition. Single-wall CNT (SWCNT) films may be highly flexible and they do not creep and crack after bending. Theoretically, they have high thermal conductivity to tolerate heat dissipation and also high radiation resistance. The synthesis of SWCNT, however, is limited to small-scale production and affected by the high cost of CNT. Other conducting polymers such as polypyrrole and polythiophene are insoluble in organic solvents and water upon doping.

Based on the above, there is thus a need to provide for a conductive polymeric material that ameliorates one or more of the drawbacks as mentioned above.

### SUMMARY

In one aspect, there is provided for a method of synthesizing a water-dispersible conductive polymeric composite comprising:

mixing an aqueous suspension comprising optionally substituted azulene monomers and a dopant precursor with an oxidizing agent and a catalyst to form a doped poly(azulene) suspension comprising an optionally substituted poly(azulene) and a dopant in a molar ratio of 1:1 to 1:6;

contacting the doped poly(azulene) suspension with acidic and basic resins to remove the oxidizing agent and the catalyst; and

filtering the doped poly(azulene) suspension to obtain a purified suspension comprising the water-dispersible conductive polymeric composite.

In another aspect, there is provided for a water-dispersible conductive polymeric composite comprising an optionally substituted poly(azulene) doped by a dopant, wherein the optionally substituted poly(azulene) and the dopant is in a molar ratio of 1:1 to 1:6.

### BRIEF DESCRIPTION OF THE DRAWINGS

The drawings are not necessarily to scale, emphasis instead generally being placed upon illustrating the principles of the invention. In the following description, various embodiments of the present disclosure are described with reference to the following drawings, in which:

FIG. 1 shows a transmittance spectrum of a poly(azulene)/polystyrene sulfonate (PAZ/PSS) film (50 nm thickness) on a glass substrate according to one embodiment of the present disclosure. Good optical transparency of the PAZ/PSS film is demonstrated via FIG. 1.

FIG. 2 shows a drop-casted PAZ/PSS dense film (7 μm thickness) on glass substrate.

FIG. 3 shows the ultraviolet-visible-near infrared (UV-vis-NIR) spectrum of a PAZ/PSS film on a glass substrate according to one embodiment of the present disclosure.

FIG. 4 shows the cyclic voltammetry curves of a PAZ/PSS film in 0.1 M LiClO₄/acetonitrile solution using Ag/AgCl as the reference electrode and Pt as the counter electrode, according to one embodiment of the present disclosure.

FIG. 5 shows the Seebeck test results for a PAZ/PSS conductive polymeric composite according to one embodiment of the present disclosure.

FIG. 6A is an illustration of a thermovoltage measurement setup according to one embodiment of the present disclosure.

FIG. 6B is an illustration of a thermocurrent measurement setup according to one embodiment of the present disclosure. The voltage across the load resistance was measured with Keithley source meter and the current was calculated using I (load)=V (measured)/R (load).

FIG. 7A shows the measured thermovoltage profile with respect to temperature and time based on the setup of FIG. 6A.

FIG. 7B shows the measured thermocurrent profile with respect to temperature and time based on the setup of FIG. 6B.

FIG. 8A shows a PAZ/PSS aqueous suspension synthesized based on the present method.

FIG. 8B compares the optical transparency of a PAZ/PSS coated substrate (PAZ/PSS thickness of 30 nm) with a control that has no PAZ/PSS coating.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and changes may be made without departing from the scope of the invention. The various embodiments are not necessarily mutually exclusive, as some embodiments can be combined with one or more other embodiments to form new embodiments.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the present disclosure, there is provided a method to synthesize a water-dispersible conductive polymeric composite. The present method and present water-dispersible conductive polymeric composite involve poly(azulene), which may be derived from azulene monomers.

The present method and present water-dispersible conductive polymeric composite may also involve a dopant and its precursor (the dopant precursor). The dopant precursor may be used to protonate azulene and/or poly(azulene). The dopant and/or its precursor may act as dispersing agent for dispersing the poly(azulene) in water for synthesis of the water-dispersible conductive polymeric composite. The dopant precursor may include, for example, polystyrene sulfonic acid. The polystyrene sulfonic acid may interact with poly(azulene) to form a mixture of the poly(azulene) and the dopant, i.e. poly(azulene)/polystyrene sulfonate (PAZ/PSS). It is to be distinguished that this mixture of the poly(azulene) and dopant does not form into copolymers. Instead, the poly(azulene) and the dopant are held together by ionic interactions. The present water-dispersible conductive polymeric composite, e.g. PAZ/PSS, derived from the present method, is therefore distinguished from conventional thermoelectric conductive polymers in that the resultant water-dispersible conductive polymeric composite is not a copolymer but a mixture of poly(azuelene) and the dopant, e.g. poly(azulene) and polystyrene sulfonate, held together by ionic interactions. Such ionic interactions may be illustrated by the broken line between the 7 membered carbon ring of PAZ and the anionic O⁻ of PSS, as a non-limiting example, in the diagram below, where n may represent any number from 2 to 10000.

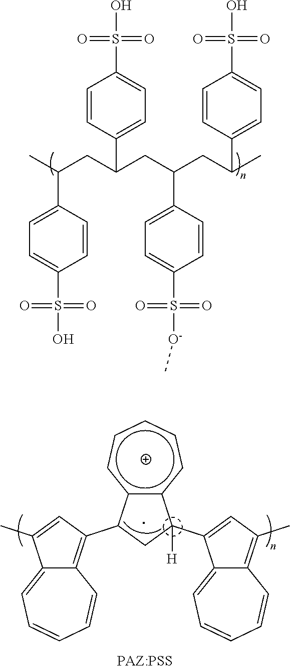

To elaborate on the ionic interaction, the basic azulene monomer is first discussed.

In the context of the present disclosure, azulene monomers are aromatic molecules having a seven membered carbon ring structure fused to a five membered carbon ring structure. Each azulene monomer has a large dipole of about 1 debye (3.34×10⁻³⁰ Cm) resulting from the electron drift from the seven membered ring structure to the five membered ring structure, which may occur as the α-positions in azulene, illustrated in the diagram below, are electron-rich, allowing the azulene to be easily protonated, for example, by acids.

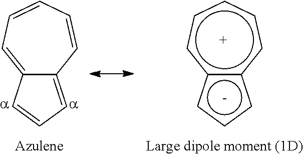

This type of fused rings lowers the reorganization energy, a parameter that strongly affects the rate of intermolecular hopping and hence the charge carrier mobility in organic semiconductors, making azulene an attractive candidate for organic electronics as demonstrated by the present disclosure. Azulene monomers and its derivatives not only exhibit electron-rich character at the α-positions but also demonstrate higher basicity than carbocyclic analogue fluorene. Accordingly, the basic azulene monomer demonstrates a highly positive response to acid, exhibiting improved optical and electronic properties. The azulene monomeric units, having the ability to be readily doped by various acids, can therefore be protonated by organic acids with significant optical and electronic properties improvements. A significant decrease of the energy band gap (more than 1.5 eV) can be achieved simply by protonation. The present method is thus advantageous in that it polymerizes azulene monomers in an aqueous solution accompanied by simultaneous protonation of the azulene moieties, thereby leading to an alternative water-dispersible conductive polymeric composite that is at least comparable or better than existing PEDOT:PSS systems at least in terms of thermoelectric properties.

Referring to the above diagram illustrating an example of the ionic interaction, the polystyrene sulfonic acid dopant precursor loses a proton to an azulene monomer or the azulene monomeric unit of the poly(azulene). This converts the polystyrene sulfonic acid into an anionic polystyrene sulfonate dopant. When the azulene becomes protonated, e.g. at the α-positions, an electron drift from the seven membered ring structure to the five membered ring structure may then occur, which in turn causes the seven membered ring structure to become positively charged. The anionic polystyrene sulfonate then interacts ionically with the positively charged seven membered ring structure of the poly(azulene), thereby forming a mixture of PAZ/PSS.

The five membered carbon ring of poly(azulene) may also have ionic interactions with the dopant (e.g. polystyrene sulfonate). As shown in the ionic interaction diagram above, upon reaction, the hydrogen ions (H⁺) on polystyrene sulfonic acid may migrate or become added to the five membered carbon ring of the azulene unit (as represented by the broken line circle). Based on this, the polystyrene sulfonic acid gets converted to anionic polystyrene sulfonate, which may then interact with the five membered carbon ring due to such a reaction. Nevertheless, the seven membered ring is generally positively charged and tends to have interaction with anionic PSS. In other words, as the H⁺ from an acid protonates the azulene unit, the overall azulene unit may remain positively charged while the PSS is negatively charged.

Advantageously, the ionic interaction provides for a higher Seebeck coefficient, which in turn improves thermoelectric performance.

Based on the present method, the water-dispersible conductive polymeric composite derivable includes, for example, PAZ/PSS. The present water-dispersible conductive polymeric composite, derived from the present method, is advantageous over conventional thermoelectric materials, such as conventional thermoelectric conductive polymers. For example, the water-dispersible conductive polymeric composite derived from PAZ/PSS exhibits a very high Seebeck coefficient, much higher than conventional PEDOT:PSS, and this contributes to a higher power factor and higher thermoelectric figure of merit.

The power factor is represented by the product of S² and σ, where S is the Seebeck coefficient (S) and σ is the electrical conductivity of a material, under a given temperature difference. The power factor may be used to assess the usefulness of a material for a thermoelectric generator or cooler (e.g. converting temperature difference to current). Materials with higher power factor are able to move more heat or extract more energy from that temperature difference. In other words, while conventional materials tend to suffer from low Seebeck coefficient, low electrical conductivity or both, the present method provides a water-dispersible conductive polymeric composite, for example, PAZ/PSS, which does not suffer such drawbacks. Besides having a high power factor, the present water-dispersible conductive polymeric composite is thermoelectric efficient, and this thermoelectric efficiency refers to the ability of a material to efficiently produce thermoelectric power, which is related to its dimensionless figure of merit, ZT, as represented by the equation below:

ZT=S²σT/κ, where S is the Seebeck coefficient, σ is the electrical conductivity, T is temperature and κ is thermal conductivity. The thermoelectric figure of merit may be referred to as figure of merit. The figure of merit is dependent on the power factor (i.e. S²σ). Based on the figure of merit, conventional thermoelectric conductive polymers, such as PEDOT:PSS, having a higher electrical conductivity compared to the present PAZ/PSS does not mean that the conventional thermoelectric conductive polymers are more efficient in generating thermoelectric power. Unlike conventional thermoelectric materials which suffer from low Seebeck coefficient, low electrical conductivity or low power factor, the present water-dispersible conductive polymeric composite, e.g. PAZ/PSS, possesses higher Seebeck coefficient, electrical conductivity and hence the higher power factor, which in turn provides for higher thermoelectric efficiency.

The present method further provides a facile route of synthesizing water-dispersible conductive polymeric composite as the components can be prepared in water, and is a one-pot synthesis method involving the use of a dopant precursor, e.g. polystyrene sulfonic acid, and inorganic oxidative salts without needing further structural modification of poly(azulene). The inorganic oxidative salts may be from the oxidizing agent and/or catalyst used for polymerization of azulene.

The conductive polymeric composite, e.g. PAZ/PSS, can be conveniently prepared in the form of an aqueous suspension, and this PAZ/PSS aqueous suspension, an alternative to PEDOT:PSS, offers several advantages over the latter. The advantages include good water dispersity, easy synthesis, good stability for long term storage and subsequent transport, and scalability for large scale production. As mentioned above, the polystyrene sulfonic acid, which interacts with poly(azulene) to form PAZ/PSS, helps to disperse the poly(azulene) in water. This not only circumvents the use of organic solvents for preparing a thermoelectric polymer but also allows the PAZ/PSS to be prepared as an aqueous suspension for subsequent film formation.

The PAZ/PSS suspension can be deposited onto various kinds of substrate to form a conductive polymeric composite film by any suitable deposition process, including but not limited to, spray-coating, drop-casting or layer-by-layer deposition. Advantageously, adhesives are not required for holding the deposited PAZ/PSS to the substrate. In other words, the resultant PAZ/PSS film achieves good adhesion to various substrates by, for example, spray-coating, drop-casting or layer-by-layer deposition, without the use of adhesives. The resultant PAZ/PSS composite (e.g. in the form of a film) is optically transparent, and is stable for storage and transport, both without the need for refrigeration.

Embodiments described in the context of the present method are analogously valid for the present water-dispersible conductive polymeric composite and its uses as described herein, and vice versa.

Before going into the details of the present method, the present water-dispersible conductive polymeric composite and its uses, the definitions of certain terms, expressions or phrases are first discussed.

In the context of the present disclosure, the expression “water-soluble” or “water-miscible” refers to substances, such as but not limited to, inorganic salts, that can (partially or entirely) dissolve in water. Meanwhile, the phrase “water-dispersible” refers to substances that do not dissolve in water but disperse in water without precipitation. An aqueous suspension, instead of an aqueous solution, may be formed using such water-dispersible substances.

In the context of the present disclosure, the phrase “optionally substituted” as used herein means the chemical group or functional group to which this phrase refers to may be unsubstituted or may be substituted.

In the context of the present disclosure, the term “alkyl” as a group or part of a group refers to a straight or branched aliphatic hydrocarbon group, including but not limited to, a C₁-C₁₂ alkyl, a C₁-C₁₀ alkyl, a C₁-C₆ alkyl. Examples of suitable straight and branched C₁-C₆ alkyl substituents include methyl, ethyl, n-propyl, 2-propyl, n-butyl, sec-butyl, t-butyl, hexyl, and the like.

In the context of the present disclosure, the term “alkoxy” as used herein refers to an —O-(alkyl) group, wherein alkyl is defined above. Examples include methoxy, ethoxy, n-propoxy, isopropoxy, tert-butoxy, and the like.

In the context of the present disclosure, the term “amine” as used herein refers to groups of the form —NRₐR_{b}, wherein Rₐ and R_{b} may be individually selected from the group including but not limited to hydrogen and optionally substituted alkyl. The definition of alkyl has been provided above. The nitrogen atom may bear a lone pair of electrons.

In the context of the present disclosure, the term “hydroxyl” refers to an —OH group.

The word “substantially” does not exclude “completely” e.g. a composition which is “substantially free” from Y may be completely free from Y. Where necessary, the word “substantially” may be omitted from the definition of the invention.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Unless specified otherwise, the terms “comprising” and “comprise”, and grammatical variants thereof, are intended to represent “open” or “inclusive” language such that they include recited elements but also permit inclusion of additional, unrecited elements.

Having defined the various terms, expressions and phrases, various embodiments of the present method, water-dispersible conductive polymeric composite and its uses, are now described below.

In the present disclosure, there is provided for a method of synthesizing a water-dispersible conductive polymeric composite comprising mixing an aqueous suspension comprising an optionally substituted azulene monomers and a dopant precursor with an oxidizing agent and a catalyst to form a doped poly(azulene) suspension comprising optionally substituted poly(azulene) and a dopant in a molar ratio of 1:1 to 1:6, contacting the doped poly(azulene) suspension with acidic and basic resins to remove the oxidizing agent and/or the catalyst, and filtering the doped poly(azulene) suspension to obtain a purified suspension comprising the water-dispersible conductive polymeric composite. The molar ratio, advantageously, helps to ensure that the poly(azulene) is doped such that there is an improvement to the Seebeck coefficient and to the dispersion of the poly(azulene) composite in water.

In various embodiments, the optionally substituted azulene monomers for forming the poly(azulene) may comprise or consist of one or more electron donating groups. The presence of one or more electron donating groups aid in efficient protonation and polymerization of azulene monomers. The expression “electron donating group” as used herein refers to a substituent that has the tendency to donate valence electrons to neighbouring atoms. Such electron donating groups may include, without being limited to, alkyl, alkoxy, amine, hydroxyl or other functional groups that have one or more lone pair of electrons with the electron donating tendency as mentioned above. In various embodiments, the optionally substituted azulene monomers may be represented by the formula:

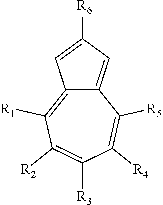

wherein R₁ to R₆ are independently selected from the group consisting C₁-C₆ alkyl, alkoxy, amine, hydrogen and hydroxyl.

The substance used to protonate the azulene, as mentioned above, is referred to herein as the dopant precursor. In addition, the dopant precursor, e.g. polystyrene sulfonic acid, helps to stabilize the azulene polymer. Such a dopant precursor may comprise or consist of organic acid. In some embodiments, the dopant precursor may comprise or consist of polystyrene sulfonic acid. The polystyrene sulfonic acid may dissociate to give up one or more protons (H⁺ ions) for protonating the azulene. In the present disclosure, the dopant precursor, including the dopant, also serves as the dispersing agent. This means that the dopant precursor not only protonates the azulene moiety but also helps to disperse the azulene moiety in water. Thus, the dopant precursor, and the dopant, not only improves the thermoelectric properties but helps to avoid use of organic solvents. Other advantages include providing poly(azulene) with good dispersability in water, which allows for long term storage and subsequent transport in water without refrigeration.

The dopant is based on the dopant precursor as used in the various embodiments. The dopant, besides the dopant precursor, also helps to stabilize the azulene polymer. In various embodiments, when the dopant precursor is polystyrene sulfonic acid, the dopant derived is polystyrene sulfonate. The dopant may comprise or consist of polystyrene sulfonate in various embodiments.

In various embodiments, the dopant precursor used may be in the range of 1 mmol to 6 mmol, 1 mmol to 5 mmol, 1 mmol to 4 mmol, 1 mmol to 3 mmol, 1 mmol to 2 mmol, 2 mmol to 6 mmol, 2 mmol to 5 mmol, 2 mmol to 4 mmol, 2 mmol to 3 mmol, 3 mmol to 6 mmol, 3 mmol to 5 mmol, 3 mmol to 4 mmol, 4 mmol to 6 mmol, 4 mmol to 5 mmol, 5 mmol to 6 mmol, etc. Other amounts of dopant precursor may be susceptible to causing instability and/or aggregation of the resultant water-dispersible conductive polymeric composite. For example, if less than 1 mmol of dopant precursor is used, and hence lesser dopant is present, the resultant product may be unstable and is likely to aggregate.

In the present method, the oxidizing agent used may comprise K₂S₂O₈, Na₂S₂O₈, H₂O₂ or AgClO₄ according to various embodiments. Such oxidizing agents tend to have a better oxidizing capability for polymerizing the azulene monomers. The oxidizing agent used may be in the range of 1 mmol to 5 mmol, 1 mmol to 4 mmol, 1 mmol to 3 mmol, 1 mmol to 2 mmol, 2 mmol to 5 mmol, 2 mmol to 4 mmol, 2 mmol to 3 mmol, 3 mmol to 5 mmol, 3 mmol to 4 mmol, 4 mmol to 5 mmol, etc. If less than 1 mmol of oxidizing agent is used, oxidation may not be completed. If an extensive amount is used, the oxidizing agent may not be easily removed subsequently and over-oxidation may occur.

In the present method, the catalyst used for polymerization of, for example, azulene monomers, may comprise Fe₂(SO₄)₃ and/or FeCl₃. The catalyst used may be in the range of 0.005 mmol to 0.015 mmol, 0.005 mmol to 0.010 mmol, 0.010 mmol to 0.015 mmol, etc. If an extensive amount of catalyst is used, over-oxidation may occur and undesired cross-linking of polymers may also occur.

In the present method, the mixing may be carried out for 30 minutes to 1 hour to form the aqueous suspension before adding the oxidizing agent and the catalyst. Such a duration helps to ensure sufficient mixing without allowing for unnecessary side reactions to occur. The mixing may be carried out by using a magnetic stirrer. In the present method, the oxidizing agent and/or catalyst may be added in any sequence to form the doped poly(azulene) suspension.

In the present method, the aqueous suspension may be formed by mixing the optionally substituted azulene monomers, dopant and water at a temperature of 5° C. to 60° C., 10° C. to 60° C., 20° C. to 60° C., 30° C. to 60° C., 40° C. to 60° C., 50° C. to 60° C., 10° C. to 50° C., 20° C. to 40° C., 20° C. to 30° C., 30° C. to 40° C., 25° C. to 45° C., 25° C. to 40° C., 25° C. to 35° C., etc. These temperatures may be used to control the polymerization rate and molecular weight of the resultant doped poly(azulene).

In various embodiments, the water used in the present method may be in the range of 10 ml to 30 ml, 10 ml to 20 ml, 20 ml to 30 ml, etc. If insufficient water is used, undesired cross-linking of the resultant polymer may occur while too much water may be too diluted for polymerization to occur properly.

In various embodiments, the optionally substituted azulene monomers may become polymerized to form the optionally substituted poly(azulene) in the presence of the oxidizing agent and the catalyst. As the optionally substituted poly(azulene) may be formed from the optionally substituted azulene monomers as described above, the optionally substituted poly(azulene) may comprise or consist of the same electron donating groups as those of the optionally substituted azulene monomers.

With the use of a dopant precursor, for example, polystyrene sulfonic acid, the azulene monomers and poly(azulene) may disperse properly in water for polymerization since the dopant precursor, including the dopant, serves as the dispersing agent as mentioned above. Thus, the aqueous solution that is formed in various embodiments may include the poly(azulene) and the dopant. Such an aqueous solution, in the context of the present disclosure, may be called a doped poly(azulene) suspension as the poly(azulene) formed is doped with polystyrene sulfonate, the latter converted from a polystyrene sulfonic acid dopant precursor. In such an instance, the polystyrene sulfonic acid protonates the poly(azulene) to form anionic polystyrene sulfonate, which is held to the protonated poly(azulene) by ionic interactions, as described above. In this regard, the term “dope” or its grammatical variant, as used herein refers to forming ionic interactions between the dopant and the poly(azulene).

In the present method, the doped poly(azulene) suspension may be stirred for a duration from 3 hours to 8 hours after mixing. The duration helps to control the molecular weight of the resultant doped poly(azulene).

After polymerization, the doped poly(azulene) suspension may be contacted with the acidic and basic resins to remove the oxidizing agent and/or the catalyst. The oxidizing agent and the catalyst to be removed may be referred to as inorganic salts. The inorganic salts, in various embodiments, may comprise Fe₂(SO₄)₃, FeCl₃, Na₂S₂O₈, H₂O₂, AgClO₄ and/or K₂S₂O₈. Any residual salts may adversely influence the measurement for Seebeck coefficient and electrical conductivity, and/or even adversely affect the Seebeck coefficient and electrical conductivity.

The acidic resin may comprise a weakly acidic cation exchanger, hydrogen form (100-200 mesh). The expression “hydrogen form (100-200 mesh)” as used herein refers to a weakly acidic cation exchanger with acidic group, where “100-200 mesh” means the exchanger size (i.e. pores of the resin) is between 100 μm to 200 μm. The basic resin may comprise a weakly basic anion exchange resin (500 μm to 700 μm pore size). A weakly acidic cation exchanger may comprise a 4 wt % cross-linked methacrylate, and a weakly basic anion exchange resin may comprise an adsorber resin functionalised with benzyl amine groups.

As mentioned above, the present method may comprise filtering the doped poly(azulene) suspension. The filtering may be carried out by passing the doped poly(azulene) suspension through a membrane or centrifuging the doped poly(azulene) suspension at 5000 to 10000 rotation per minute (rpm). In various embodiments, the membrane may comprise or consist of polyvinylidene fluoride (PVDF).

Another advantage of the present method is that the mixing, the contacting and the filtering may be carried out without any restrictions on humidity and oxygen level.

The present disclosure also provides for a water-dispersible conductive polymeric composite comprising an optionally substituted poly(azulene) doped by a dopant, wherein the optionally substituted poly(azulene) and the dopant is in a molar ratio of 1:1 to 1:6. Various embodiments of the present method, and advantages associated with various embodiments of the present method, as described above, may be applicable to the present water-dispersible conductive polymeric composite and its uses, and vice versa.

In various embodiments, the water-dispersible conductive polymeric composite may be in the form of a suspension or a film. The suspension may be an aqueous suspension. Water may be used in forming the aqueous suspension. The water-dispersible conductive polymeric composite may exist as particles, or nanoparticles, in the aqueous suspension. Such particles may not dissolve in water but are dispersible in water.

In various embodiments, the optionally substituted poly(azulene) may be derived from a plurality of optionally substituted azulene monomeric units each comprising a fused bicyclic structure, wherein the fused bicyclic structure may comprise a five membered carbon ring fused to a seven membered carbon ring.

In various embodiments, the optionally substituted poly(azulene) may be doped with the dopant via ionic interactions. This has been described above. In various embodiments, the dopant may comprise polystyrene sulfonate. The polystyrene sulfonate dopant may be from de-protonation of a polystyrene sulfonic acid dopant precursor.

In various embodiments, the ionic interactions may be between the polystyrene sulfonate and the seven membered carbon ring, and/or the ionic interactions may be between the polystyrene sulfonate and the five membered carbon ring.

In summary, the present disclosure describes a water-dispersible conducting polymer system derived from, without being limited to, azulene and polystyrene sulfonic acid, which demonstrates good stability, uniformity and highly desirable electrical conductivity. For uniformity, it refers to a smooth film, derived from the present method and present water-dispersible conductive polymeric composite, that has lower variation in height changes across the surface of the film.

While the methods described above are illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

### EXAMPLES

The present disclosure relates to a method for preparing a water-dispersible conducting polymer material, for example, a poly(azulene)/polystyrene sulfonate (PAZ/PSS). The present method may be used to fabricate a film comprising such a water-dispersible conducting polymer material. The present disclosure also relates to use of such water-dispersible conducting polymer material. The present method, water-dispersible conductive polymer material, and its uses, are described, by way of examples, as set forth below.

### Example 1: Synthesis of Water-Dispersible Conductive Polymeric Composite

In this example, a method to synthesize a water-dispersible conductive polymeric composite is described. Azulene (AZ) (99%), poly(4-styrenesulfonic acid) solution (molecular weight of about 75,000, 18 weight percent (wt %) in H₂O), potassium persulfate (K₂S₂O₈) (99%) and iron(III) chloride (FeCl₃) (97%) were purchased from Sigma-Aldrich. Other commercially available solvents and reagents were used as received. The water-dispersible conductive polymeric composite being illustrated is a water-dispersible PAZ/PSS, exhibiting good electrical conductivity, good dispersity, a high Seebeck coefficient, with good adhesion to substrates such as glass, indium tin oxide (ITO) and a wafer.

The PAZ/PSS solution was synthesized via in-situ polymerization. Firstly, azulene (AZ) (1 mmol), polystyrene sulfonic acid solution (2 mmol to 2.5 mmol) and water (10 ml to 30 ml) were mixed and stirred rigorously at room temperature. After 30 minutes, K₂S₂O₈ (1 mmol to 5 mmol) and a catalytic amount of Fe₂(SO₄)₃ (0.01 mmol) were added into the mixture. Other oxidizing agents and catalyst that have been described above may be used. The resultant mixture was stirred rigorously for another 6 hours. The aqueous solution was washed by basic resin(s) and acidic resin(s) accordingly to remove the inorganic salts (i.e. oxidizing agent and/or catalyst), followed by passing through a PVDF membrane to obtain a purified PAZ/PSS solution. In this PAZ/PSS solution, the PAZ and PSS do not form copolymers but remain as a mixture of polymers held together by ionic interactions. The purified PAZ/PSS solution can then be deposited, for example, by drop-casting, onto a substrate to form a PAZ/PSS conductive polymeric composite film.

The inorganic salts are from the oxidizing agent and/or catalyst. That is to say, the inorganic salts, to be removed by the acidic and/or basic resins, may be the oxidizing agent and/or the catalyst.

The polystyrene sulfonic acid may have a molecular weight in the range of 25,000 g/mol to 1,000,000 g/mol.

The acidic resin may comprise a weakly acidic cation exchanger, hydrogen form (100-200 mesh). The expression “hydrogen form (100-200 mesh)” refers to a weakly acidic cation exchanger with acidic group, where “100-200 mesh” means the exchanger size (i.e. pores of the resin) is from 100 μm to 200 μm.

The basic resin may comprise a weakly basic anion exchange resin (500 μm to 700 μm). A weakly acidic cation exchanger may comprise a 4 wt % cross-linked methacrylate, and a weakly basic anion exchange resin may comprise an adsorber resin functionalised with benzyl amine groups.

### Example 2: Characterization and Discussion on the Water-Dispersible Conductive Polymeric Composite

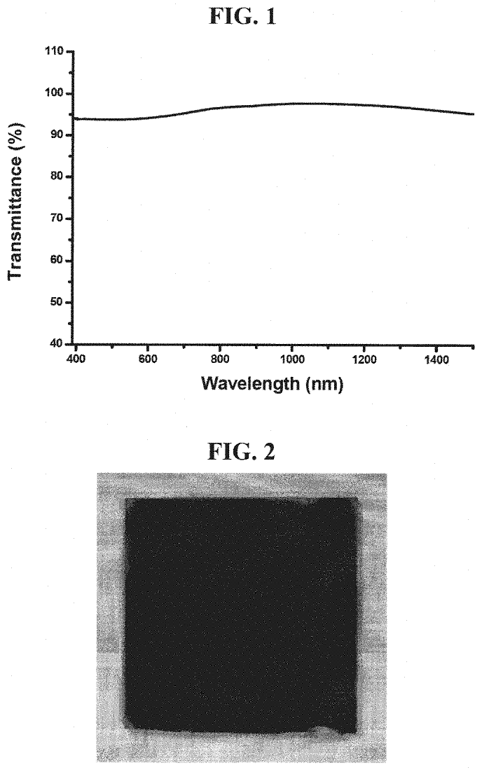

As illustrated in the above example, PAZ/PSS is synthesized via a one-step in-situ polymerization. Azulene is susceptible to protonation by both organic and mineral acids, and its α-position at the 5-membered ring is reactive with high proton affinity. Polystyrene sulfonic acid serves as the dopant precursor (i.e. doping additive) and dispersing agent to help stabilize the resultant PAZ. Therefore, PAZ/PSS exhibits a high conductivity, good dispersity and high transparency (based on FIG. 1).

In the present method, PAZ synthesis was conducted in water, advantageously, without any restrictions nor constraints on the humidity and oxygen level, making the present method and the present PAZ/PSS conductive polymeric composite suitable for real life applications.

FIG. 2 shows a drop-casted PAZ/PSS film on a glass substrate derived according to one embodiment of the present method. The film thickness, estimated by a surface profiler, was about 7 μm.

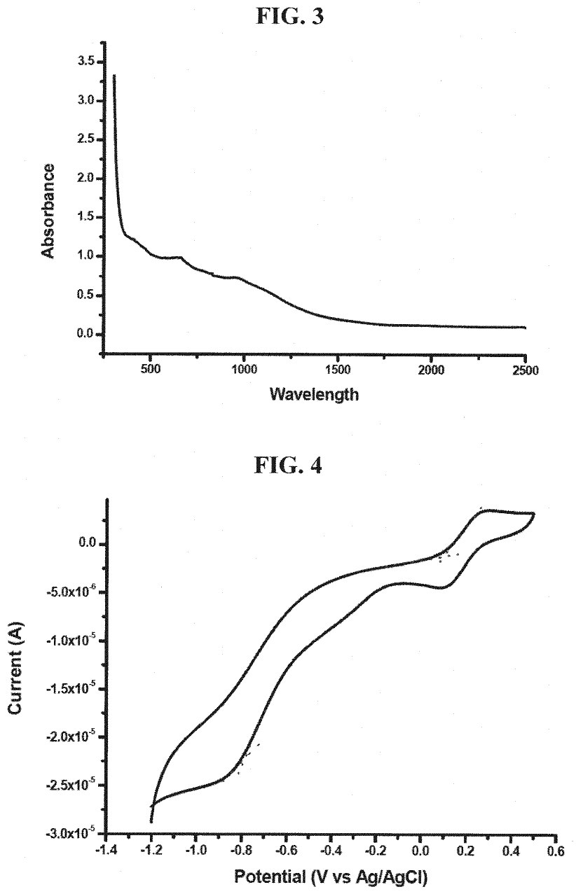

In order to examine the physical properties of PAZ/PSS, the absorption spectrum was also measured. As observed from FIG. 3, the absorption spectrum for PAZ/PSS is quite broad, ranging from 300 nm to 1900 nm with the onset at 1480 nm. The extra low band gap of 0.84 eV for PAZ/PSS was obtained.

A cyclic voltammetry test was conducted at a scan rate of 25 mV/s to determine the highest occupied molecular orbital (HOMO) and lowest unoccupied molecular orbital (LUMO) levels of PAZ/PSS. Both reduction and oxidation peaks were observed, as shown in FIG. 4. Upon calculation, HOMO of −4.52 eV and LUMO of −3.68 eV were obtained, corresponding to the values observed based on UV-vis-NIR spectroscopy.

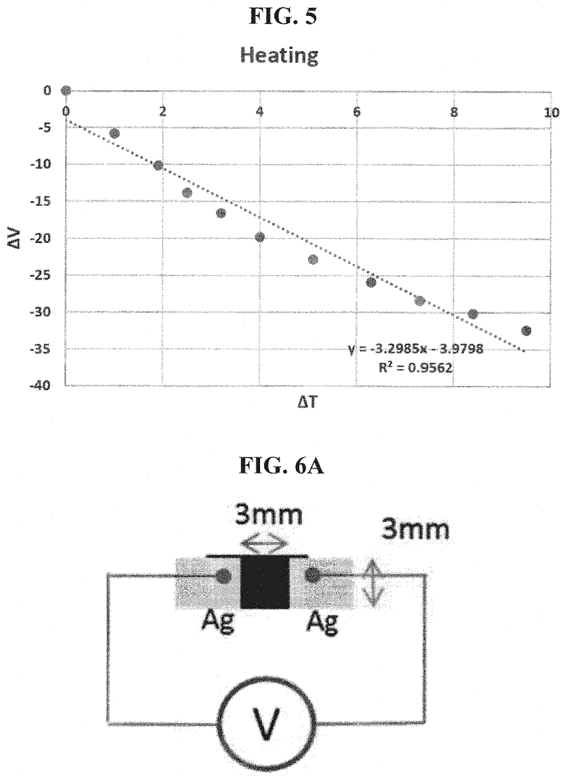

The efficiency of thermoelectric materials, figure of merit (i.e. ZT), can be expressed as ZT=S²σT/κ. In this equation, S is the Seebeck coefficient, σ is the electrical conductivity, T is temperature and κ is thermal conductivity. Based on this equation, S has a vital role for achieving a high ZT value. Conventionally, for organic thermoelectric materials, various efforts were made to increase the electrical conductivity (σ) but not the Seebeck coefficient. For example, the Seebeck coefficient (S) of conventional PEDOT:PSS remains very low (less than 90 μV/K). Meanwhile, for the present disclosure, as shown in FIG. 5 and table 1 (presented below), upon heating, the Seebeck coefficient of PAZ/PSS reaches as high as 3300 μV/K, and the a of PAZ/PSS is 0.17 S/cm to 0.18 S/cm as measured via a four-probe test. Based on these results of a PAZ/PSS derived by the present method, the present PAZ/PSS conductive polymeric composite attains a corresponding power factor (S²σ) of 196 μW/m/K²(based on a of 0.18 S/cm).

In table 1 below, Tc refers to the cold side temperature of the module setup (e.g. the PAZ/PSS film material). Th refers to the hot side temperature of the module setup (e.g. the PAZ/PSS film material). ΔT refers to the temperature difference between Th and Tc. V refers to the voltage measured. ΔV refers to the voltage difference between the preceding voltage measured and the following voltage that is measured.

TABLE 1
Seebeck Data Upon Heating for PAZ/PSS

| Tc/° C. | Th/° C. | ΔT/° C. | V/mV | (ΔV)/mV |
|---|---|---|---|---|
| 23.7 | 23.7 | 0.0 | 58.6 | 0.0 |
| 24.4 | 25.4 | 1.0 | 52.7 | −5.81 |
| 25.0 | 26.9 | 1.9 | 48.4 | −10.2 |
| 25.7 | 28.2 | 2.5 | 44.7 | −13.8 |
| 26.5 | 29.7 | 3.2 | 42.0 | −16.6 |
| 27.2 | 31.2 | 4.0 | 38.7 | −19.8 |
| 27.7 | 32.8 | 5.1 | 35.7 | −22.8 |
| 27.9 | 34.2 | 6.3 | 32.6 | −25.9 |
| 28.3 | 35.6 | 7.3 | 30.1 | −28.4 |
| 28.6 | 37.0 | 8.4 | 28.4 | −30.2 |
| 28.6 | 38.1 | 9.5 | 26.1 | −32.4 |

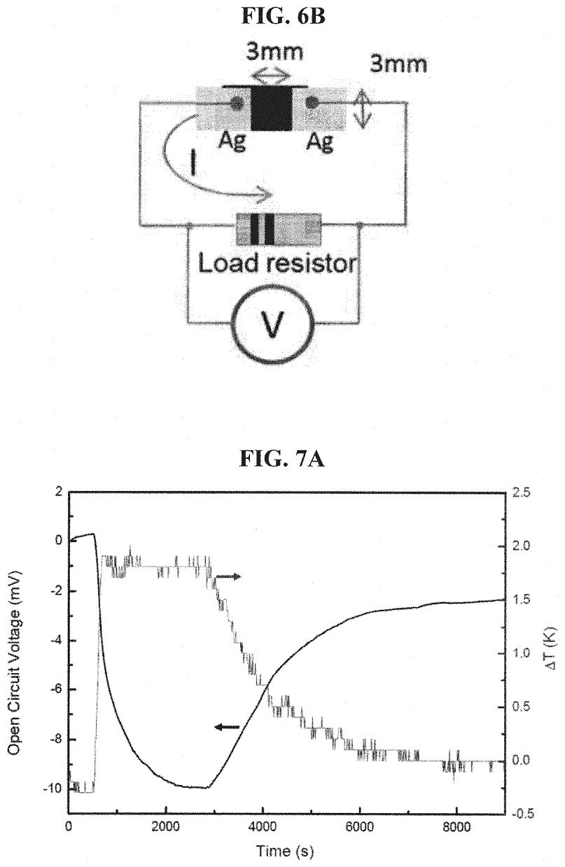

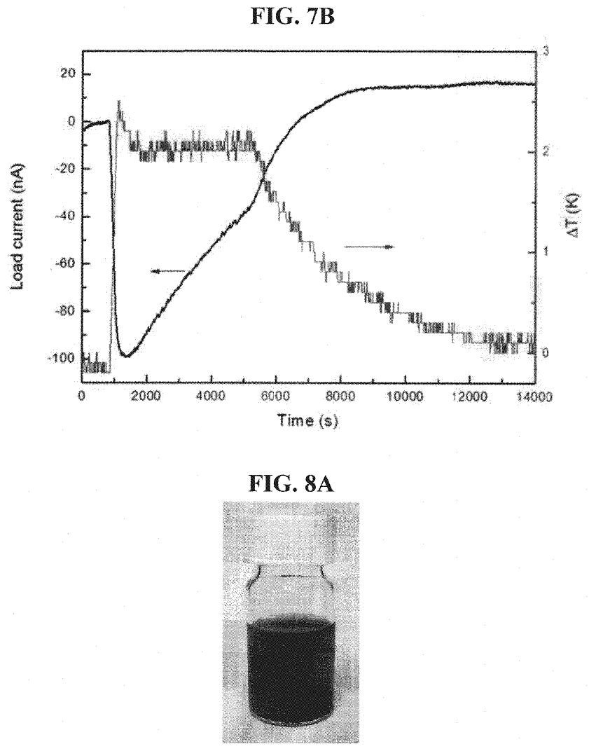

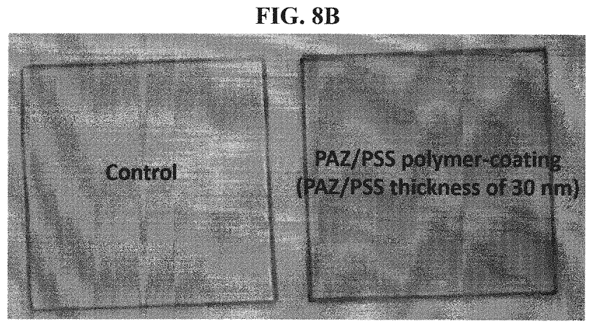

FIG. 6A and FIG. 6B show the setup for measuring time-dependent thermovoltage and thermocurrent, respectively, using silver paste as electrodes. The corresponding measured results for PAZ/PSS are shown in FIG. 7A and FIG. 7B, respectively. At a temperature difference of about 1.8 K, the thermovoltage reached 10 mV after heating of 1500 seconds. This voltage was maintained for as long as the constant heating was supplied. Hence, the thermovoltage for PAZ/PSS is sustainable, as compared to thermovoltage of PEDOT:PSS which is not sustainable. As for the thermocurrent of PAZ/PSS, it only drops to half after 3000 seconds, which is observable in conventional materials due to a typical ion effect. Such thermoelectric cell based on PAZ/PSS is therefore demonstrated to have sustainable thermovoltage and quasi-sustainable thermocurrent that are useful for energy harvesting from an intermittent heat source for providing an instant electrical supply.

### Example 3: Potential Applications and Advantages

The above examples demonstrate that PAZ/PSS is advantageous for manufacturing an electrically conductive polymer composition comprising conductive PAZ/PSS in water. The thermoelectric properties of the resultant PAZ/PSS are superior over conventional conductive polymers. Conventional thermoelectric materials tend to suffer from low thermoelectric efficiency and this limits their applications. Organic thermoelectric materials, a kind of conventional thermoelectric materials, tend to suffer from low electrical conductivity and/or low Seebeck coefficient, as well as poor processability upon treatment. The present method and the present water-dispersible polymeric composite overcome one or more of these drawbacks.

The present method is advantageous as it uses water-dispersible poly(azulene), involving polystyrene sulfonic acid and polystyrene sulfonate, a combination that provides good water dispersion. The conductive polymeric composite may be synthesized via one-pot in-situ polymerization of azulene monomer in the presence of, for example, poly(4-styrenesulfonic acid) in water. The resultant water-dispersible conductive polymeric composite, derived based on poly(azulene), is water-dispersible, non-toxic, easy to fabricate, and has good film forming ability. The polymeric composite, for example, PAZ/PSS, may be in the form of a particle, having a size of about 0.4 μm to about 2 μm, about 0.5 μm to about 2 μm, about 1 μm to about 2 μm, about 1.5 μm to about 2 μm, about 0.5 μm to about 1.5 μm, about 1 μm to about 1.5 μm, about 0.5 μm to about 1 μm, etc. The PAZ to PSS molar ratio in the resultant PAZ/PSS material may be from 1:1 to 1:6, 1:1 to 1:5, 1:1 to 1:4, 1:1 to 1:3 or 1:1 to 1:2 in some embodiments. Advantageously, the resultant PAZ/PSS exhibits a large Seebeck coefficient of about 3000 μV/K to about 5000 μV/K and a high electrical conductivity of about 0.1 S/cm to about 1 S/cm. The PAZ/PSS is also electrically and thermally stable.

The present method and present water-dispersible conductive polymeric composite can be used in applications, such as thermoelectric devices, sensors, transparent conductors, touch panel displays, detectors, ionic supercapacitors and/or actuators.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method of synthesizing a water-dispersible conductive polymeric composite comprising:
mixing an aqueous suspension comprising optionally substituted azulene monomers and a dopant precursor with an oxidizing agent and a catalyst to form a doped poly(azulene) suspension comprising an optionally substituted poly(azulene) and a dopant in a molar ratio of 1:1 to 1:6;
contacting the doped poly(azulene) suspension with acidic and basic resins to remove the oxidizing agent and the catalyst; and
filtering the doped poly(azulene) suspension to obtain a purified suspension comprising the water-dispersible conductive polymeric composite.

2. The method according to claim 1, wherein the mixing is carried out for 30 minutes to 1 hour to form the aqueous suspension before adding the oxidizing agent and the catalyst.

3. The method according to claim 1, wherein the aqueous suspension is formed by mixing the optionally substituted azulene monomers, the dopant precursor and water at a temperature of 5° C. to 60° C.

4. The method according to claim 1, wherein the optionally substituted azulene monomers are represented by the formula: 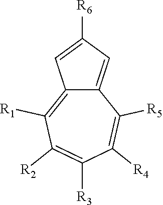
wherein R1 to R6 are independently selected from the group consisting C1-C6 alkyl, alkoxy, amine, hydrogen and hydroxyl.

5. The method according to claim 1, wherein the dopant precursor is in the range of 1 mmol to 6 mmol.

6. The method according to claim 1, wherein the dopant precursor comprises polystyrene sulfonic acid.

7. The method according to claim 1, wherein the dopant comprises polystyrene sulfonate.

8. The method according to claim 1, wherein the oxidizing agent comprises K₂S₂O₈, Na₂S₂O₈, H₂O₂ or AgClO₄.

9. The method according to claim 1, wherein the oxidizing agent is in the range of 1 mmol to 5 mmol.

10. The method according to claim 1, wherein the catalyst comprises Fe₂(SO₄)₃ and/or FeCl₃.

11. The method according to claim 1, wherein the catalyst is in the range of 0.005 mmol to 0.015 mmol.

12. The method according to claim 1, wherein the doped poly(azulene) suspension is stirred for 3 hours to 8 hours after mixing.

13. The method according to claim 1, wherein the filtering is carried out by passing the doped poly(azulene) suspension through a membrane or centrifuging the doped poly(azulene) suspension at 5000 to 10000 rotation per minute (rpm).

14. The method according to claim 1, wherein the membrane comprises polyvinylidene fluoride.

15. The method according to claim 1, wherein the mixing, the contacting and the filtering are carried out without any restrictions on humidity and oxygen level.

16. A water-dispersible conductive polymeric composite comprising an optionally substituted poly(azulene) doped by a dopant, wherein the optionally substituted poly(azulene) and the dopant is in a molar ratio of 1:1 to 1:6.

17. The water-dispersible conductive polymeric composite according to claim 16, wherein the water-dispersible conductive polymeric composite is in the form of a suspension or a film.

18. The water-dispersible conductive polymeric composite according to claim 16, wherein the optionally substituted poly(azulene) is derived from a plurality of optionally substituted azulene monomeric units each comprising a fused bicyclic structure, wherein the fused bicyclic structure comprises a 5 membered carbon ring fused to a 7 membered carbon ring, and wherein the optionally substituted poly(azulene) is doped with the dopant via ionic interactions.

19. (canceled)

20. The water-dispersible conductive polymeric composite according to claim 16, wherein the dopant comprises polystyrene sulfonate.

21. The water-dispersible conductive polymeric composite according to claim 18, wherein the dopant comprises polystyrene sulfonate.
